(19) United States
(12) Patent Application Publication
(10) Pub. No.: US 2019/0222891 A1
(43) Pub. Date: Jul. 18, 2019

(54) SYSTEMS AND METHODS FOR MANAGING PRESENTATION SERVICES

(71) Applicant: Melo Inc., San Jose, CA (US)

(72) Inventors: Guobin Shen, Beijing (CN); Zheng Han, Beijing (CN)

(73) Assignee: Melo Inc., San Jose, CA (US)

(21) Appl. No.: 16/248,146

(22) Filed: Jan. 15, 2019

Related U.S. Application Data
(60) Provisional application No. 62/618,700, filed on Jan. 18, 2018.

(51) Int. Cl. H04N 21/4415; H04N 21/258; G06F 21/32

(52) U.S. Cl. CPC H04N 21/4415; G06F 21/32; H04N 21/25875

(57) ABSTRACT

Systems and methods for managing a presentation service are provided. An exemplary system may include at least one memory storing computer-executable instructions and at least one processor in communication with the memory. The computer-executable instructions, when executed by the processor, cause the processor to perform operations. The operations may include receiving, from a terminal device, identification information of a user. The operations may also include determining whether the user enrolls in the presentation service based on the identification information. In response to a determination that the user enrolls in the presentation service, the operations may include selecting presentation information associated with the user in a content database. The operations may further include causing a display device associated with the terminal device to display at least part of the presentation information.

### RELATED APPLICATIONS

This application claims the benefits of priority to U.S. Provisional Application No. 62/618,700, filed Jan. 18, 2018, the entire contents of which are expressly incorporated herein by reference.

### TECHNICAL FIELD

The present application relates to systems and methods for managing a presentation service, and more particularly, to systems and methods for automatically displaying presentation contents on a display device based on identification information of a user captured by a terminal device associated with the display device.

### BACKGROUND

Presentation is a common form of communication and is routinely used in meetings, conferences, conventions, etc. In a typical presentation, a presenter would convey information to an audience, usually by a speech accompanied by presentation materials, such as a series of visual exhibitions, which are often projected by a projector to a big screen. In order to show the visual exhibitions using the projector, electronic file(s) containing the visual exhibitions need to be loaded to a computer connected to the projector prior to the presentation. In current presentation systems, the overall presentation experience is often not smooth, particularly in the preparation stage (e.g., connecting a presentation device to the projector, finding the right presentation deck to present, etc.) and the transition stage (e.g., switching presentation devices or presentation decks for different presenters). Many glitches can occur during presentation setup and transition using the current systems. For example, when a single presenter presents using a personal device (e.g., a laptop computer) that needs to be coupled to the projector, issues like unmatched connection adaptors, unmatched display setup (e.g., unmatched display resolution), limited battery life, etc., may arise. In cases with multiple presenters, the chance of such glitches likely increases due to, for example, the multiple switching of presentation devices. As a result, presentation time is wasted, and the effect of the presentation is compromised.

One workaround to reduce the occurrences of the above-mentioned glitches is to use a dedicated presentation device and preload presentation materials before the meeting, conference, etc. This workaround may avoid onsite switching of presentation devices to avoid potential issues associated therewith. However, in cases with multiple presenters, the presenters may still experience difficulties in finding and selecting the right presentation materials corresponding to their respective presentation topics. Thus, a dedicated person is required to manually organize the presentation materials to ensure that they are properly ordered on the dedicated device and may even need to manually switch the presentation materials during the presentations.

### SUMMARY

In one aspect, a system for managing a presentation service is provided. The system may include at least one memory storing computer-executable instructions and at least one processor in communication with the memory. The computer-executable instructions, when executed by the processor, cause the processor to perform operations. The operations may include receiving, from a terminal device, identification information of a user. The operations may also include determining whether the user enrolls in the presentation service based on the identification information. In response to a determination that the user enrolls in the presentation service, the operations may include selecting presentation information associated with the user in a content database. The operations may further include causing a display device associated with the terminal device to display at least part of the presentation information.

In another aspect, a method for managing a presentation service is provided. The method may include receiving, from a terminal device, identification information of a user. The method may also include determining whether the user enrolls in the presentation service based on the identification information. In response to a determination that the user enrolls in the presentation service, the method may include selecting presentation information associated with the user in a content database. The method may further include causing a display device associated with the terminal device to display at least part of the presentation information.

In a further aspect, a non-transitory computer-readable medium storing instructions is provided. The instructions, when executed by at least one processor, cause the processor to perform a method for managing presentation services. The method may include receiving, from a terminal device, identification information of a user. The method may also include determining whether the user enrolls in the presentation service based on the identification information. In response to a determination that the user enrolls in the presentation service, the method may include selecting presentation information associated with the user in a content database. The method may further include causing a display device associated with the terminal device to display at least part of the presentation information.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system for managing a presentation service, according to embodiments of the disclosure.

FIG. 2 illustrates a block diagram of another exemplary system for managing a presentation service, according to embodiments of the disclosure.

FIG. 3 illustrates a block diagram of a server used in the systems shown in FIGS. 1 and 2, according to embodiments of the disclosure.

FIG. 4 illustrates a block diagram of a terminal device used in the systems shown in FIGS. 1 and 2, according to embodiments of the disclosure.

FIG. 5 is a flowchart of an exemplary method for managing presentation information during a preparation stage, according to embodiments of the disclosure.

FIG. 6 is a flowchart of an exemplary method for providing a presentation service during a presentation stage, according to embodiments of the disclosure.

FIG. 7 illustrates a block diagram of an exemplary distributed presentation service architecture, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provides a presentation service to address issues and glitches often experienced during a presentation. In some embodiments, the presentation service may use a server to store presentation information and automatically select the correct presentation information based on identification information of a user (e.g., a presenter, speaker, performer, or the like). The server may be coupled to at least one terminal device configured to capture the identification information. A user may preload (e.g., upload via a web interface, email to a dedicated service account, etc.) his/her presentation information to the server in advance of the meeting, conference, etc. When the user is about to present, the user may simply walk to the stage or otherwise signal the terminal device in the meeting room, which may capture identification information of the user. Based on the identification information, the server may determine whether the user enrolls in the presentation service, and if so, automatically select corresponding presentation information associated with the user. The selected presentation information may be downloaded to the terminal device, which may in turn show the presentation information on a connected display device. In some embodiment, the server may generate a media stream based on the selected presentation information and send the media stream to a networked display device for display. Embodiments of the disclosure avoid the needs to switch presentation devices and manually organize/select presentation information, thereby improving the presentation efficiency and enhancing the presentation experience.

As used herein, a “presentation” refers to any suitable form of conveying or communicating information, including, for example, a speech, a talk, a performance, a product demonstration, a show, an announcement, an introduction, a lecture, a debate, or the like. “Presentation information” refers to any information related to a presentation, including, for example, a slide deck, a video, an audio recording, a music, a movie clip, a document, a spreadsheet, or any other form of materials that assist in conveying or communicating the topic(s), idea(s), and/or content(s) of the presentation. In some embodiments, presentation information may be compiled or otherwise organized in an electronic file, such as a PowerPoint file developed by Microsoft, a Keynote file developed by Apple, a PDF file developed by Adobe, etc.

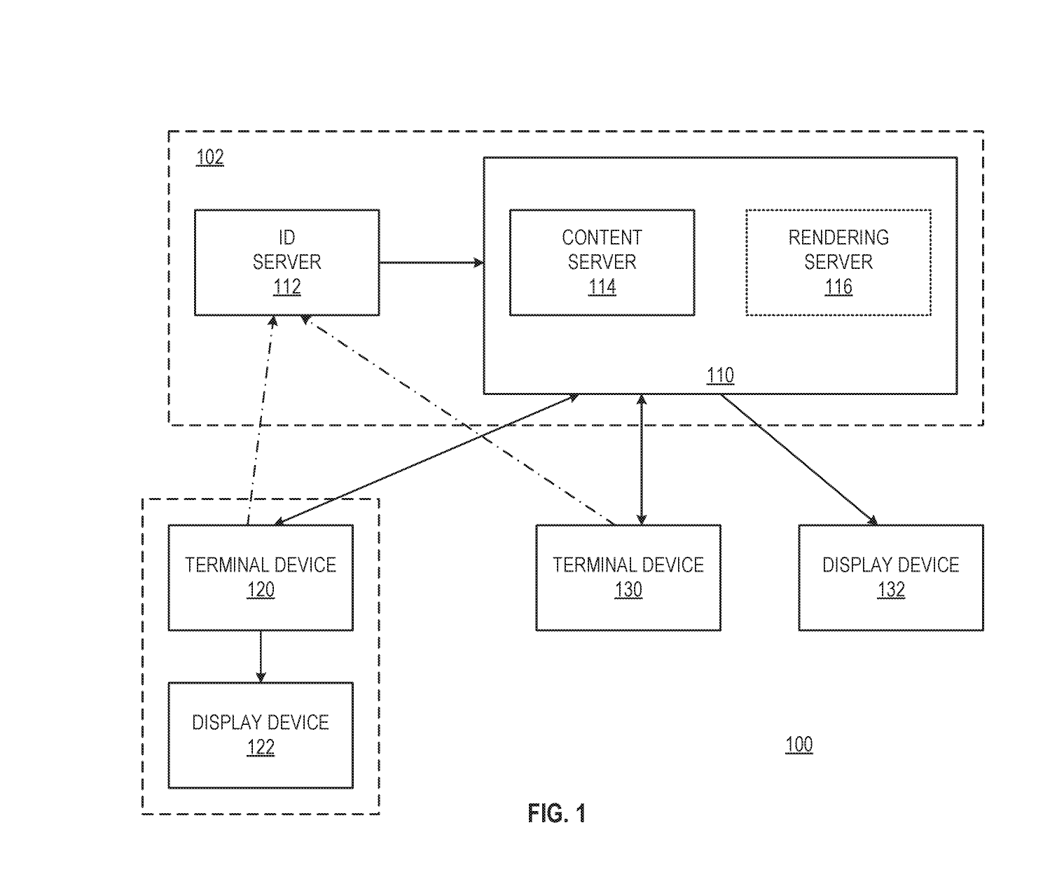

FIG. 1 shows a block diagram of an exemplary system 100 for managing a presentation service, according to embodiments of the disclosure. As shown in FIG. 1, system 100 may include a server 102, one or more terminal devices such as 120 and 130, and one or more display devices such as 122 and 132. In some embodiments, server 102 may be implemented as a backend server using, for example, a cloud-based system or a distributed network system, to manage the presentation service. The presentation service may be provided as software as a service (SaaS) and implemented as a web-, browser-, and/or app-based application, or may be provided as a traditional software package installed on a computer.

Terminal device 120/130 may be used as a frontend device configured to capture identification information of a user. The identification information may be used to identify a specific user and/or determine whether the user enrolls in or registers to the presentation service. In some embodiments, one or more terminal devices 120/130 may communicate with server 102 via communication links such as network connections.

The one or more display devices 122/132 may include a projector, a TV, an LED display panel, or the like. As shown in FIG. 1, display device 132 may be a networked display device capable of directly connecting to server 102. Display device 122 may be a local display device connected to a local terminal device 120 in a wired and/or wireless fashion.

In some embodiments, a display device may be associated with a terminal device, or vice versa. For example, display device 122 may be directly connected to terminal device 120, thereby associated with terminal device 120. In this case, server 102 may or may not store association information between terminal device 120 and display device 122. In another example, terminal device 130 and display device 132 may be collocated in a meeting room, a conference hall, etc., such that terminal device 130 may capture identification information of a user, based on which presentation information can be displayed on display device 132. In this case, display device 132 may be associated with terminal device 130 through association information maintained by server 102, regardless of whether terminal device 130 can establish a local connection with display device 132. In some embodiments, association information may be obtained by server 102 during a registration process of a terminal device (e.g., with information of its associated display device(s)) and/or a display device (e.g., with information of its associated terminal device(s)).

Terminal device 120/130 may be implemented as a stand-alone hardware device, an add-on hardware device, or an integrated hardware component of another device. For example, terminal device 130 may be a stand-alone device separate from display device 132. In another example, terminal device 120 may be an add-on device to display device 122 or integrated as part of display device 122. In some embodiments, a display device may be configured to implement the functionalities of a terminal device. For example, one or more functions of terminal device 120 may be implemented as built-in functions of display device 122. In some embodiments, a terminal device may be implemented by installing a software application to a general-purpose computer, such as a desktop, a laptop, a workstation, a smart phone, a tablet, or the like. In this way, part or all of the functions of terminal device 120 may be implemented by executing the software application.

As shown in FIG. 1, server 102 may include one or more component servers, such as an identification (ID) server 112, a content server 114, and an optional rendering server 116. Each server may provide a service. For example, ID server 112 may provide identification service; content server 114 may provide content storage service; rendering server 116 may provide media rendering service. These component servers may be stand-alone servers or may be implemented as one or more integral servers. FIG. 1 shows an embodiment in which ID server 112 is implemented as a stand-alone server, while content server 114 and rendering server 116 are integrated as an integral server, hereinafter referred to as presentation server 110. In the embodiment shown in FIG. 1, ID server 112 may be implemented as a dedicated identification server that may serve not only applications related to the presentation service disclosed herein but also other applications via, for example, application programming interfaces (APIs). ID server 112 may implement various protocols, such as Open Authorization (OAuth).

In some embodiments, ID server 112 may include an identity database that stores identification information related to the users of the presentation service disclosed herein, such as various types of user credentials (e.g., user ID, user name, login ID, access code, etc.) and/or biological features of the users. The identification information may be stored in the identity database as records, which may be inquired, retrieved, compared with, and/or matched to identification information captured by terminal device 120/130. For example, ID server 112 may include a matching engine configured to match a user credential and/or a biological feature obtained based on identification information of a user captured by terminal device 120/130 with records stored in the identity database. In some embodiments, terminal device 120 may extract the biological feature (e.g., vocal feature, facial feature, fingerprint pattern, iris feature, etc.) from the captured identification information (e.g., voice, video, etc.). In other embodiments, terminal device 112 may send the captured identification information to ID server 112, and ID server 112 may extract the biological feature based on the captured identification information. The extracted biological feature may be used for identifying the user, for example, determining whether the user enrolls in the presentation service managed by server 102. For example, the matching engine may match the extracted biological feature against all previously collected biological features related to the user. To improve the efficiency of this matching, ID server 112 may retrieve corresponding biological features from the identity database based on, for example, known identities of multiple users, and then match the extracted biological feature against a smaller set of biological features. In some embodiments, the matching engine may be implemented at terminal device 120/130 (e.g., one or more cameras, one or more microphones, or the like) and/or at presentation server 110.

Content server 114 may include a content database that manages presentation information such as electronic files. In some embodiments, content server 114 may also manage metadata related to the files. Content server 114 may provide APIs for retrieving, uploading, or downloading files. The retrieving API may receive an authenticated ID of a user, date and time, one or more identifications of terminal devices, and other metadata, and may use the received information to select one or more target files associated with the user. The selected target file(s) may be sent to rendering server 116 and/or back to a terminal device (e.g., terminal device 120). In embodiments in which rendering server 116 is provided, rendering server 116 may receive the target file(s) from the retrieve API and open and render the content therein. Rendering server 116 may also permit user interactions (e.g., advancing slides, returning to previous slides, playing video and/or audio, operating audience polls, etc.) during the presentation. In some embodiments, rendering server 116 may automatically launch an appropriate application to open a file based on, for example, the file suffix of a target file. For example, rendering server 116 may launch Microsoft PowerPoint for handling a .pptx file, Microsoft Word for a .docx file, Adobe Acrobat Reader for a .pdf file, or the like. In some embodiments, a similar rendering engine may additionally or alternatively be implemented on a terminal device or a display device. For example, when display device 132 includes a rendering engine, display device 132 may be directly connected to the presentation server 110 even if rendering server 116 is not present.

Terminal device 120/130 may include hardware components configured to capture certain identification information related to a user, such as a smartcard reader that directly retrieves a user credential, biological information acquisition device(s) such as a microphone and/or a camera to capture a user's voice and/or image to extract vocal features and/or facial features, or the like. These biological features may be used to identify the user and obtain a unique ID associated with the user. As discussed above, the identification process may occur at the terminal device side and/or at the server side. In some embodiments, the user credential may be directly obtained by terminal device 120/130 and sent to ID server 112. In some embodiments, the biological features may be sent to ID server 112.

In some embodiments, one or more terminal devices may be connected to server 102 via network connections. Server 102 may assign a unique ID to each connected terminal device. A terminal device may further be associated with one or more collocated display devices. A display device may be locally connected (e.g., wired and/or wirelessly) to the terminal device(s) and/or directly connected to presentation server 110. In embodiments where a display device, such as display device 132, is directly connected to presentation server 110, the collocated terminal device (e.g., terminal device 130) may be associated to the display device explicitly, and presentation server 110 may maintain the corresponding association information. A terminal device may further be equipped with an operating system and optionally one or more applications in communication with presentation server 110. One or more of the applications may further handle files sent from presentation server 110 in one or more formats and/or may manage user interactions during the presentation process. Accordingly, terminal device 120/130 may include, at least in part, a rendering engine similar to rendering server 116.

Terminal device 120/130 may be aggregated or disaggregated and may include one or more dedicated devices and/or be integrated with one or more other devices. For example, terminal device 120 may comprise a dedicated computer with an internal and/or external camera and/or a microphone, a hardware module integrated with display device 122, etc.

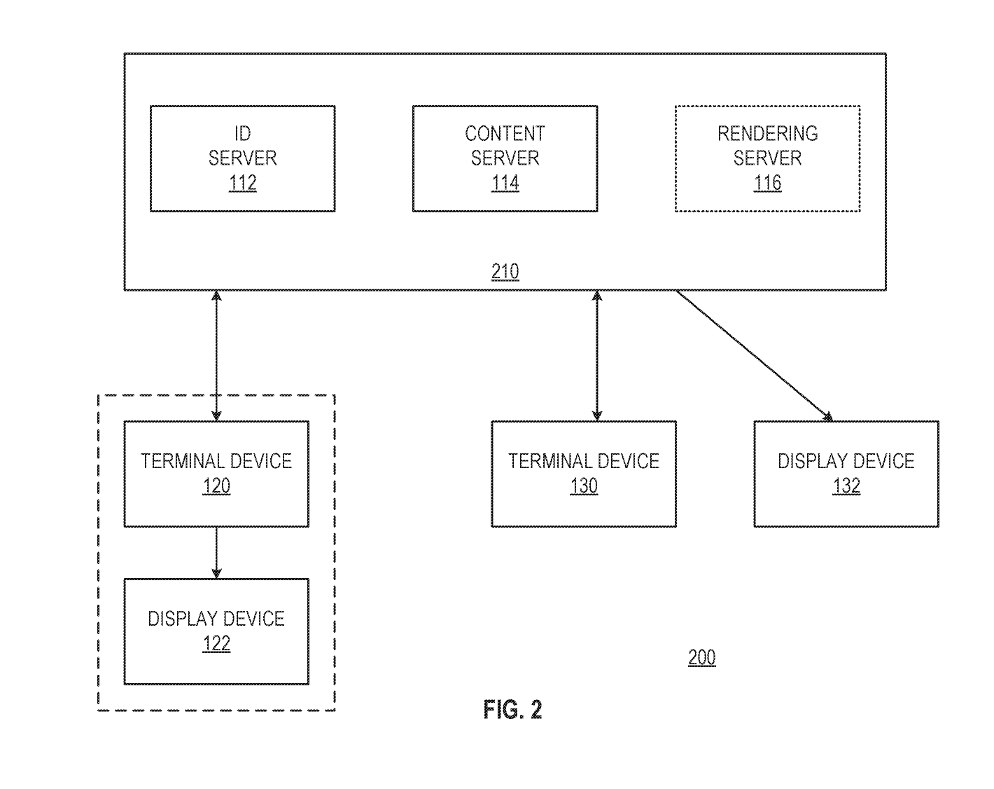

FIG. 2 shows a block diagram of another exemplary system 200 in which ID server 112, content server 114, and rendering server 116 are integrated together as an integral presentation server 210 (hereinafter referred to as presentation server 210). Other components shown in FIG. 2 are similar to those shown in FIG. 1. Therefore, detail descriptions of individual components shown in FIG. 2 are omitted. It is noted that other embodiments with different combinations of integration and stand-alone servers/components may also be used.

The integration or separation of component servers may affect the information flow of identification information related to the user. For example, in the embodiment shown in FIG. 1 where ID server 112 is implemented as a stand-alone server, identification information captured by terminal device(s) 120/130 may flow to ID server 112 (shown in dotted-dash lines), which then sends authenticated ID information to other servers, such as presentation server 110. In addition, the user may need to, when first using the presentation service, explicitly authorize the stand-alone ID server 112 to send authenticated ID information to presentation server 110.

In the embodiment shown in FIG. 2, where ID server 112 is integrated into presentation server 210, identification information captured by terminal device(s) 120/130 may flow directly to presentation server 210. Communication of authenticated ID information in this embodiment may be performed as an internal information exchange. Accordingly, it may not be necessary for the user to explicitly authorize ID server 112 to send authenticated ID information to other components/servers.

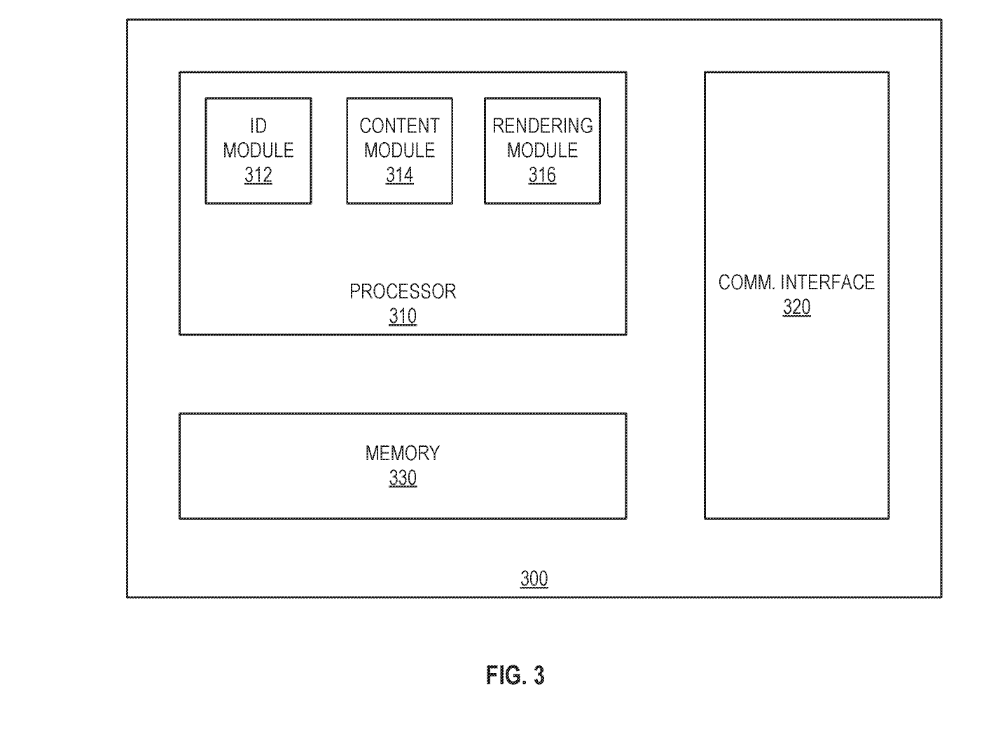

FIG. 3 shows a block diagram of an exemplary server 300 for managing the presentation service disclosed herein. Server 300 can be a local physical server, a cloud server, a virtual server, a distributed server, or any other suitable computing system. Server 300 may be configured to implement functions of server 110 or 210, or any component thereof, such as ID server 112, content server 114, and rendering server 116.

As shown in FIG. 3, server 300 may include a processor 310, a communication interface 320, and a memory 330. In some embodiments, server 300 may have different modules co-located within a single device, such as within an integrated circuit (IC) chip (e.g., implemented as an application-specific integrated circuit (ASIC) or a field-programmable gate array (FPGA)), or within separate devices having dedicated functions. Some or all of the components of server 300 may be located in a cloud computing environment, provided in a single location, or provided in distributed locations.

Communication interface 320 may be configured to send information to and receive information from other components of system 100 or 200 via communication links indicated by arrowed lines shown in FIGS. 1 and 2. In some embodiments, communication interface 320 can include an integrated services digital network (ISDN) card, cable modem, satellite modem, or a modem to provide a data communication connection. As another example, communication interface 320 can include a local area network (LAN) card to provide a data communication connection to a compatible LAN. Wireless links can also be implemented by communication interface 320. In such an implementation, communication interface 320 can send and receive electrical, electromagnetic or optical signals that carry digital data streams representing various types of information via the communication links.

Processor 310 may include one or more processing devices configured to perform functions of the disclosed methods. Processor 310 may include any appropriate type of general-purpose or special-purpose microprocessor, digital signal processor, graphic processor, or microcontroller. In some embodiments, processor 310 may include a single core or multiple cores executing parallel processes simultaneously. For example, processor 310 can be a single-core processor configured with virtual processing technologies. In certain embodiments, processor 310 uses logical processors to simultaneously execute and control multiple processes. Processor 310 can implement virtual machine technologies, or other known technologies to provide the ability to execute, control, run, manipulate, and store multiple software processes, applications, programs, etc. In another embodiment, processor 310 may include a multiple-core processor arrangement (e.g., dual core, quad core, etc.) configured to provide parallel processing functionalities that allow server 300 to execute multiple processes simultaneously. As discussed in further detail below, processor 310 may be specially configured with one or more modules for performing method steps and functions of the disclosed embodiments. It is appreciated that other types of processor arrangements can be implemented that provide for the capabilities disclosed herein.

Memory 330 may include a volatile or non-volatile, magnetic, semiconductor-based, tape-based, optical, removable, non-removable, or other type of storage device or tangible and/or non-transitory computer-readable medium that stores one or more executable programs, such as a presentation service application and an operating system. The programs may include software that, when executed by processor 310, performs functions of one or more modules to be discussed in greater detail below. The programs may also include communication software that, when executed by processor 310, provides communications using communication interface 320, such as web browser software, tablet or smart handheld device networking software, etc.

As shown in FIG. 3, processor 310 may include an ID module 312 configured to implement the functions of ID server 112. For example, ID module 312 may be configured to receive identification information such as voice and/or image of a user captured by terminal device 120/130, extract biological features from the identification information, and matching the extracted biological features with previously obtained biological features stored as records in an identity database. In another example, ID module 312 may receive a user credential captured by terminal device 120/130 and match the user credential with previously obtained user credentials stored as records in the identity database. In some embodiments, ID module 312 may authenticate a user based on the identification information and determine that the user enrolls in the presentation service after the user is authenticated. For example, after the user is authenticated, the user may be assigned a unique ID, which may indicate that the user is an enrolled or registered user of the presentation service. The unique ID may be used to locate presentation information such as one or more presentation files previously uploaded to server 300.

Processor 310 may include a content module 314 configured to implement the functions of content server 114. For example, content module 314 may be configured to receive presentation information from a user through user uploading, store the presentation information in a content database (e.g., in memory 330), search for a particular record of presentation information in the content database based on user identity or identification information of the user, and select and retrieve the presentation information associated with the user from the content database.

Processor 310 may include a rendering module 316 configured to implement the functions of rendering server 116. For example, rendering module 316 may be configured to automatically launching an application to open a file containing the presentation information associated with a user based on, for example, the file suffix of the file. In another example, rendering module 316 may be configured to facilitate user interactions (e.g., advancing slides, returning to previous slides, playing video and/or audio, operating audience polls, etc.) during the presentation.

It is noted that although FIG. 3 shows that modules 312-316 are all within processor 310, this is only for illustration purposes. Processor 310 may include any individual or combination of modules 312-316. For example, in some embodiments, rendering module 316 may be omitted when the rendering processing can be performed on the terminal device side. In another example, ID module 312 may be implemented by a stand-alone server separate from the server that implements content module 312 and/or rendering module 316.

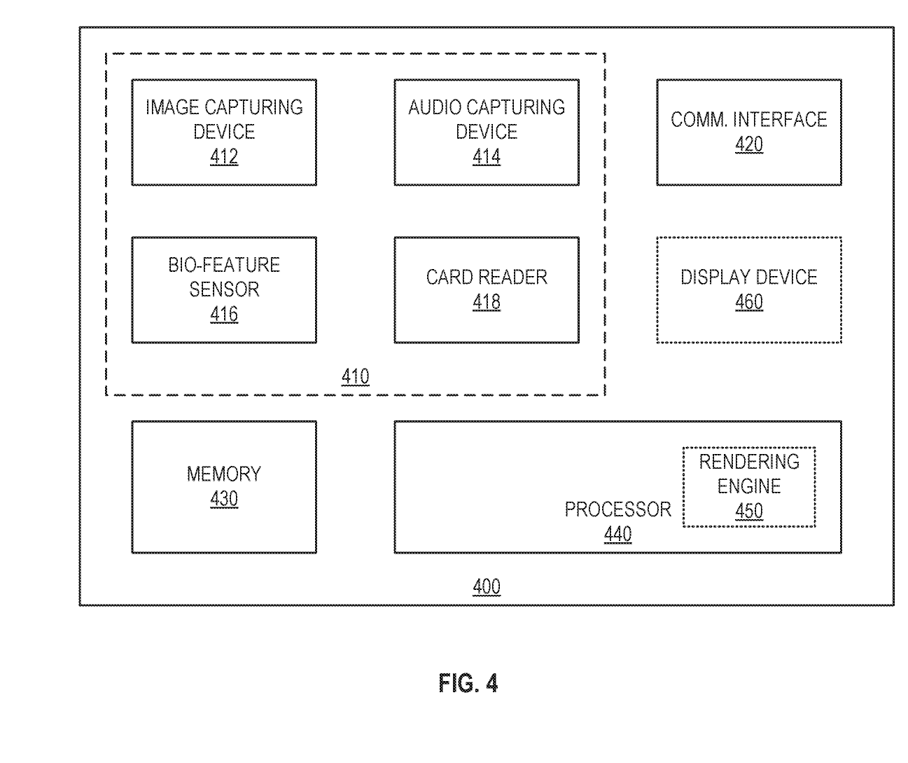

FIG. 4 shows a block diagram of an exemplary terminal device 400 for capturing identification information of a user. Terminal device 400 may be any hardware device capable of capturing identification information of a user. For example, terminal device 400 may be a computer with one or more camera and/or microphone, a mobile phone, a tablet, a smart TV, etc. As shown in FIG. 4, terminal device 400 may include an identification information capturing unit 410. Unit 410 may include one or more devices/sensors for capturing identification information, such as an image capturing device 412 (e.g., a camera) configured to capture an image or video of the user, an audio capturing device 414 (e.g., a microphone) configured to capture a voice of the user, a bio-feature sensor 416 such as a fingerprint detector, an iris scanner, a face detector, etc., and a card reader 418 configured to read a user credential encoded in a smartcard, or a wireless tag such as an RFID tag or NFC tag. Terminal device 400 may also include a processor 440, a memory 430, and a communication interface 420, similar to processor 310, memory 330, and communication interface 320, respectively, with design features suitable for terminal device usage.

In some embodiments, processor 440 may include a rendering engine 450 configured to perform rendering and/or user interaction functions, similar to rendering module 316. In some embodiments, terminal device 400 may include a display device 460 that implements functions of display device 122/132. In some embodiments, display device 122/132 may be equipped with one or more components of terminal device 400 shown in FIG. 4 such that terminal device 400 is integrated with display device 460.

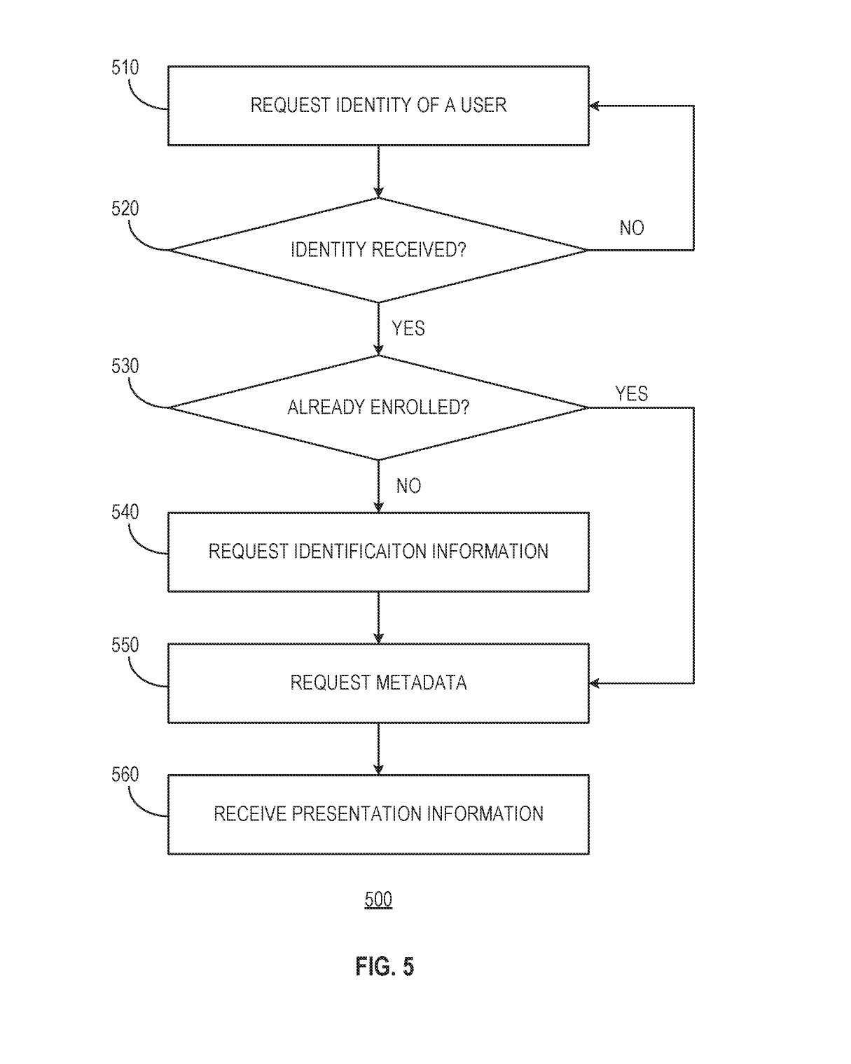

In some embodiments, the overall work flow of system 100/200 may include two phases: a preparation phase and a presentation phase. FIG. 5 is a flowchart of an exemplary method 500 for managing a presentation service during a presentation stage, according to embodiments of the disclosure. Method 500 may be implemented by server 300 that includes, among other things, memory 330 and processor 310 that performs various operations using one or more modules 312-316. In some embodiments, method 500 may be jointly performed by server 300 and terminal device 400. It is to be appreciated that some of the steps of method 500 may be optional to perform the disclosure provided herein, and that some steps may be inserted in the flowchart of method 500 that are consistent with other embodiments according to the current disclosure. Further, some of the steps may be performed simultaneously, or in an order different from that shown in FIG. 5.

In the preparation phase, a user may upload his/her presentation information to server 110/210, for example, via file upload APIs. Referring to FIG. 5, in step 510, processor 310 may request the identity of a user before granting the user access to the presentation service. In step 520, processor 310 may check if the identity is received. If not, method 500 loops back to step 510. Otherwise, method 500 proceeds to step 530, in which processor 310 may check the identity database and determine whether the user has already enrolled. If not, processor 310 may request the user to upload identification information, e.g., a recent portrait photo, a recent voice clip, a voice recording, etc., or to send other ID information to processor 310 through an ID acquisition device, such as a smartcard reader. If processor 310 determines that the user has already enrolled, then step 540 may be skipped.

In step 550, processor 310 may request the user to send some metadata. The metadata may be used to retrieve the user's file(s) during the presentation phase. In one example, the metadata may include a company ID associated with the user, a designated talk time, an indicator of audience scope (e.g., public, open only to company employees, etc.), or the like. The metadata may be used to organize the user's file(s) and may increase the probability of selecting a correct file from a plurality of files during file retrieval, since a user may have multiple presentation decks stored in presentation server 110/210. In some embodiments, the specified talk time may also serve as an indicator of presentation file expiry such that the user's file(s) can be deleted when they expire.

In step 560, processor 310 may receive presentation information such as presentation files provided by the user. In some embodiments, the user may upload the file(s) via a web interface, may email the files (e.g., as an attachment) to a designated email account (e.g., with a specific subject line), optionally with metadata in one or more specific content formats.

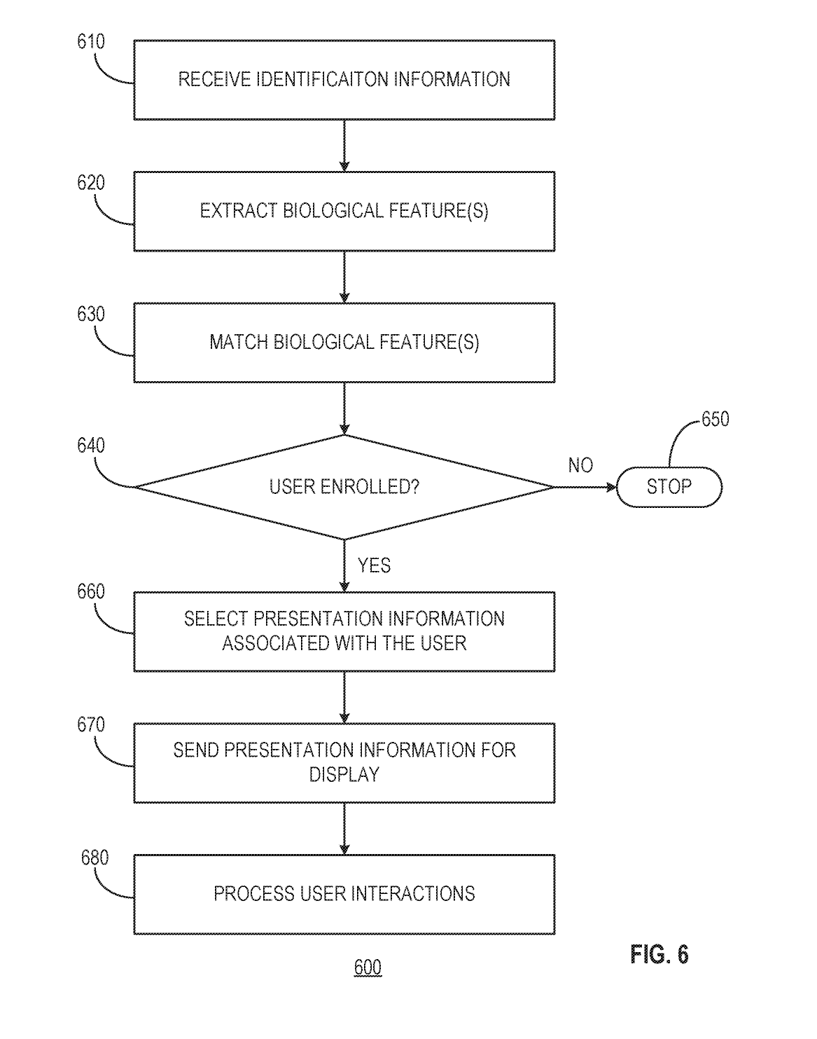

FIG. 6 is a flowchart of an exemplary method 600 for providing a presentation service during a presentation stage, according to embodiments of the disclosure. Method 600 may be implemented by server 300 that includes, among other things, memory 330 and processor 310 that performs various operations using one or more modules 312-316. In some embodiments, method 600 may be jointly performed by server 300 and terminal device 400. It is to be appreciated that some of the steps of method 600 may be optional to perform the disclosure provided herein, and that some steps may be inserted in the flowchart of method 600 that are consistent with other embodiments according to the current disclosure. Further, some of the steps may be performed simultaneously, or in an order different from that shown in FIG. 6

In step 610, processor 310 may receive identification information related to a user captured by one or more terminal devices 120/130. For example, a user may walk up to the stage and/or speak a predetermined hot word (e.g., “Hello Melo”) such that his/her face may be captured and/or voice recorded by the terminal device(s). In step 620, processor 310 may extract biological features such as vocal and/or facial features from the capture identification information. In step 630, processor 310 may match the biological features with previously obtained biological features (e.g., using ID module 312 and/or comparing the biological features against a local database). If a matching biological feature is located, processor 310 may obtain a unique ID for the user and determine that the user is enrolled in step 640. If the captured biological features do not match any record, then processor 310 may determine that the user is not enrolled, and method 600 proceeds to step 650, where the presentation service stops for the user. Optionally, the requesting time and/or the ID of the terminal device may be captured. Such information may be sent to presentation server 110/120 to facilitate retrieving user's file(s). In another example, the vocal and/or facial features may be extracted at the terminal device side. In such an example, the vocal and/or facial features may be sent to presentation server 110/120.

In step 660, processor 310 may select presentation information associated with the user from the content database. If multiple candidate files exist, the file list may be obtained.

In step 670, the selected file may be retrieved from the content database and sent to the terminal device(s). If multiple candidate files exist, the file list may be returned to the terminal device(s) such that the user may select the correct file from the list (e.g., via a voice or gesture interaction). Depending on whether the display device is locally connected to the terminal device (e.g., display device 122 and terminal device 120) and if the terminal device is capable of rendering the retrieved file, the file may be downloaded by the terminal device and processed locally (e.g., shown by terminal device 120 and display device 122 in FIG. 1) or may be directly streamed from the presentation server's rendering server (e.g., to display device 132 should in FIG. 1).

In step 680, processor 310 may process user interaction using rendering module 316. The user interactions may include voices and/or gestures, in addition to conventional mouse/keyboard/remote control and other extant devices. In embodiments where the terminal device 120/130 has a microphone and a camera to capture the user's voice and gestures, rendering module 316 may utilize advances in voice and gesture recognition (e.g., using deep neural networks with pre-trained models) such that natural voices and gesture-based interaction may be used.

In some embodiments, the presentation service may be implemented in a centralized manner, e.g., as one or more cloud-based services. For example, a business or entity may deploy the presentation service in a private cloud and/or using dedicated server(s), thereby using a centralized embodiment. In some embodiments, the presentation server and the terminal device(s) may be integrated together to form an integrated presentation server (IPS). Such an IPS device may be connected to a local network and may be shared by local network users. Such an embodiment may be preferable, for example, for a small business having limited number of display device(s).

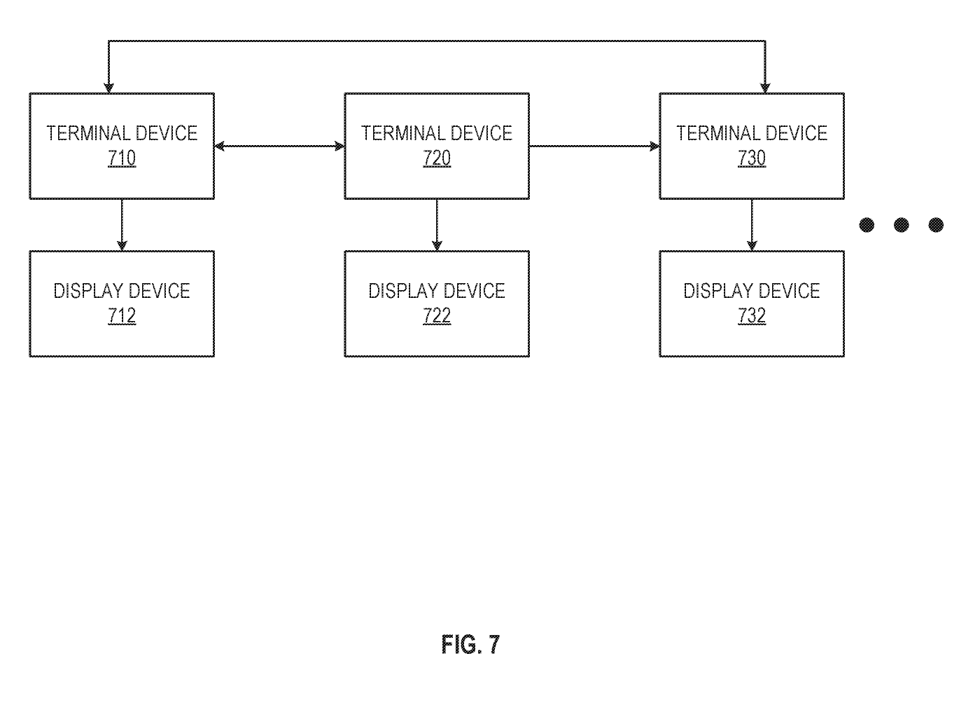

Multiple IPS devices may be aggregated through certain distributed protocols (e.g., for handling database replication, file storage, and retrieval) and thereby forming a distributed presentation service such that users may use the service across multiple meeting rooms/display devices, as shown in FIG. 7. In FIG. 7, multiple terminal device/display device combo or set (710/712, 720/722, 730/732, etc.) may be aggregated and interconnected to form a distributed presentation service. This architecture may be an alternate embodiment to the centralized embodiment described above, and may also be incrementally deployed. In some embodiments, the distributed presentation service may use a distributed hash tree (DHT) based protocol. In such a configuration, the user's files may be stored locally, with each DHT node maintaining pointers to all uploaded files on other nodes. In one example, an association database may be synced, merged, and fully replicated across all nodes.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. The computer-readable medium may be a disc, a flash drive, or a solid-state drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A system for managing a presentation service, comprising:
at least one memory storing computer-executable instructions; and
at least one processor in communication with the memory, wherein the computer-executable instructions, when executed by the processor, cause the processor to perform operations comprising:
receiving, from a terminal device, identification information of a user;
determining whether the user enrolls in the presentation service based on the identification information;
in response to a determination that the user enrolls in the presentation service, selecting presentation information associated with the user in a content database; and
causing a display device associated with the terminal device to display at least part of the presentation information.

2. The system of claim 1, wherein:
the identification information comprises at least one biological feature of the user; and
the operations comprise:
matching the biological feature with records stored in an identity database; and
determining that the user enrolls in the presentation service when at least one record matches the biological feature.

3. The system of claim 1, wherein:
the identification information comprises a voice of the user; and
the operations comprise:
extracting a vocal feature from the voice;
matching the vocal feature with records stored in an identity database; and
determining that the user enrolls in the presentation service when at least one record matches the vocal feature.

4. The system of claim 1, wherein;
the identification information comprises an image of the user; and
the operations comprise:
extracting a facial feature from the video;
matching the facial feature with records stored in an identity database; and
determining that the user enrolls in the presentation service when at least one record matches the facial feature.

5. The system of claim 1, wherein:
the identification information comprises a user credential; and
the operations comprise:
matching the user credential with records stored in an identity database; and
determining that the user enrolls in the presentation service when at least one record matches the user credential.

6. The system of claim 1, wherein the operations comprise:
authenticating the user based on the identification information; and
determining that the user enrolls in the presentation service after the user is authenticated.

7. The system of claim 1, wherein:
the display device is coupled to the terminal device; and
the operations comprise:
sending the presentation information to the terminal device for displaying at least part of the presentation information on the display device.

8. The system of claim 1, wherein the operations comprise:
generating, by a rendering engine, a media stream based on the presentation information; and
sending the media stream to the display device for displaying at least part of the presentation information on the display device.

9. The system of claim 1, wherein:
the presentation information includes an electronic file containing a presentation content; and
the operations comprise:
automatically launching an application to open the electronic file based on at least one property of the electronic file.

10. A method for managing a presentation service, comprising:
receiving, from a terminal device, identification information of a user;
determining whether the user enrolls in the presentation service based on the identification information;
in response to a determination that the user enrolls in the presentation service, selecting presentation information associated with the user in a content database; and
causing a display device associated with the terminal device to display at least part of the presentation information.

11. The method of claim 10, wherein:
the identification information comprises at least one biological feature of the user; and
the method comprises:
matching the biological feature with records stored in an identity database; and
determining that the user enrolls in the presentation service when at least one record matches the biological feature.

12. The method of claim 10, wherein:
the identification information comprises a voice of the user; and
the method comprises:
extracting a vocal feature from the voice;
matching the vocal feature with records stored in an identity database; and
determining that the user enrolls in the presentation service when at least one record matches the vocal feature.

13. The method of claim 10, wherein:
the identification information comprises an image of the user; and
the method comprises:
extracting a facial feature from the video;
matching the facial feature with records stored in an identity database; and
determining that the user enrolls in the presentation service when at least one record matches the facial feature.

14. The method of claim 10, wherein:
the identification information comprises a user credential; and
the method comprises:
matching the user credential with records stored in an identity database; and
determining that the user enrolls in the presentation service when at least one record matches the user credential.

15. The method of claim 10, comprising:
authenticating the user based on the identification information; and
determining that the user enrolls in the presentation service after the user is authenticated.

16. The method of claim 10, wherein:
the display device is coupled to the terminal device; and
the method comprises:
sending the presentation information to the terminal device for displaying at least part of the presentation information on the display device.

17. The method of claim 10, comprising:
generating, by a rendering engine, a media stream based on the presentation information; and
sending the media stream to the display device for displaying at least part of the presentation information on the display device.

18. The method of claim 10, wherein:
the presentation information includes an electronic file containing a presentation content; and
the method comprises:
automatically launching an application to open the electronic file based on at least one property of the electronic file.

19. A non-transitory computer-readable medium storing instructions that, when executed by at least one processor, cause the processor to perform a method for managing presentation services, the method comprising:
receiving, from a terminal device, identification information of a user;
determining whether the user enrolls in the presentation service based on the identification information;
in response to a determination that the user enrolls in the presentation service, selecting presentation information associated with the user in a content database; and
causing a display device associated with the terminal device to display at least part of the presentation information.

20. The non-transitory computer-readable medium of claim 20, wherein:
the identification information comprises at least one biological feature of the user; and
the method comprises:
matching the biological feature with records stored in an identity database; and
determining that the user enrolls in the presentation service when at least one record matches the biological feature.
